(19) United States
(12) Patent Application Publication
(10) Pub. No.: US 2008/0171561 A1
(43) Pub. Date: Jul. 17, 2008

(54) APPARATUS FOR AND METHOD OF RADIO LINK ESTABLISHMENT BETWEEN TWO COMMUNICATION DEVICES

(75) Inventors: Ran Irony, Hod Hasharon (IL); Itay Sherman, Ra'anana (IL)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/622,039

(22) Filed: Jan. 11, 2007

(51) Int. Cl. H04Q 7/20; H04B 7/26

(52) U.S. Cl. 455/466; 455/41.2

(57) ABSTRACT

A novel and useful apparatus for and method of automatically establishing a secondary communications link (e.g., short range wireless connection such as WLAN, Bluetooth, etc.) between two communications devices utilizing an already established primary communications connection (e.g., cellular phone connection). The invention eliminates the need for both sides of a connection to manually initiate and configure their communication devices in order to establish a wireless connection. Connection parameters required to establish the link are configured on only one communication device (e.g., cellular phone), without the need to also configure them on the communication device on the other end of the connection. Messages containing the connection parameters are sent from the requesting (or initiating) side over the established primary connection to the target or destination side of the connection.

### FIELD OF THE INVENTION

The present invention relates to the field of data communications and more particularly relates to an apparatus, method and system for establishing a radio link between two communication devices, such as cellular phones.

### BACKGROUND OF THE INVENTION

Currently there are numerous consumer electronics communications devices such as portable multimedia players, add-ons for portable multimedia players, cellular telephones, personal digital assistants (PDAs), etc. that support a primary communications connection in addition to one or more secondary communications connections. Considering communication devices such as cellular phones, for example, an increasing number of cellular phones today support both the basic primary cellular communications connection as well as support one or more secondary connections such as Bluetooth and Wireless Local Area Network (WLAN) which permit direct connection between cellular phones. Other short distance wireless technologies such as ultra wideband (UWB) and others are to be incorporated into cellular phones in the next several years.

The case where the communications devices comprise cellular phones is shown in FIG. 1. The example prior art scenario, generally referenced 10, comprises two cellular phones (cellular phone A 12 and cellular phone B 14) connected via a cellular based connection 20. A Bluetooth connection 22 is established between the two cellular phones as well.

Considering the example above, the Bluetooth connection is normally disabled by default in each cellular phone so as to minimize the power consumption from constantly scanning for a connection. Thus, each user must manually initiate a Bluetooth connection, as indicated by the connection initiation reference 16 to cellular phone A and the connection initiation reference 18 to cellular phone B. The consequence of this is that in order to initiate a connection (such as Bluetooth) between the two cellular phones, both users much configure their respective cellular phone manually which is an annoyance for both users.

In WLAN networks, this problem is even bigger since in WLAN networks there are numerous parameters that much be configured between both sides before any communications can occur.

It is therefore desirable to have a mechanism whereby a connection between two communication devices can be initiated in a much simpler manner when compared to the prior art arrangement. Further, the mechanism should be to establish a connection without causing a significant increase in power consumption.

### SUMMARY OF THE INVENTION

The present invention is a novel and useful apparatus for and method of automatically establishing a secondary communications link (e.g., short range wireless connection) between two communications devices utilizing an already established primary communications connection (e.g., cellular phone connection). The invention eliminates the need for both sides of a connection to manually initiate and configure their communication devices in order to establish a wireless connection. The mechanism of the invention is particularly applicable to wireless communication devices that incorporate secondary wireless connection technology such as any of the short range wireless standards currently in use. Examples of short range wireless technologies in common use today include wireless local area network (WLAN), Bluetooth and Ultra Wideband (UWB).

Typically, the short range wireless capability is provided as an addition to a primary wired or wireless technology such as a conventional cellular link. For example, the invention can be used to initiate and establish Bluetooth, WLAN or UWB connections between two cellular phones.

Connection parameters required to establish the link are configured on only one communication device (e.g., cellular phone), without the need to also configure them on the communication device on the other end of the connection. One or more messages comprising the configuration parameters are sent from the requesting (or initiating) side over the established primary connection to the target or destination side of the connection. Examples of the parameters that must be configured for a WLAN link, for example, comprise SSID, IP address subnet, security policy, security keys, etc.

One advantage of the automatic link establishment mechanism is that it permits the communication devices to keep their secondary link radios off thus significantly reducing power consumption and extending the life of battery dependent mobile devices. Thus, the invention saves power while maintaining constant secondary link connectivity of the communications device without requiring user configuration on the target or destination side of the connection.

Reduced power consumption is likely to lead to an increase in the number of users of secondary connection features in the cellular marketplace.

Note that some aspects of the invention described herein may be constructed as software objects that are executed in embedded devices as firmware, software objects that are executed as part of a software application on either an embedded or non-embedded computer system such as a digital signal processor (DSP), microcomputer, minicomputer, microprocessor, etc. running a real-time operating system such as WinCE, Symbian, OSE, Embedded LINUX, etc. or non-real time operating system such as Windows, UNIX, LINUX, etc., or as soft core realized HDL circuits embodied in an Application. Specific Integrated Circuit (ASIC) or Field Programmable Gate Array (FPGA), or as functionally equivalent discrete hardware components.

There is thus provided in accordance with the invention, a method of establishing a secondary communications link between a first communication device and a second communication device connected via a primary communications link, the method comprising the steps of receiving a request to initiate the secondary communication link on the first communication device, in response to the request, generating a message comprising configuration parameters for initiating the secondary communication link between the first communication device and the second communication device, sending the message to the second communication device over the primary communications link and establishing the secondary communications link between the first communication device and the second communication device in accordance with the configuration parameters.

There is also provided in accordance with the invention, a method of establishing a short range wireless connection between a first cellular phone and second cellular phone, both the first cellular phone and the second cellular phone connected to a conventional cellular network, the method comprising the steps of receiving a request to initiate the short range wireless connection on the first cellular phone, in response to the request, generating a message comprising configuration parameters for initiating the short range wireless connection between the first cellular phone and the second cellular phone, sending the message to the second cellular phone over the cellular network and establishing the short range wireless connection between the first cellular phone and the second cellular phone in accordance with the configuration parameters.

There is also provided in accordance with the invention, a mobile communications device comprising a cellular radio transceiver operative to connect the mobile communications device to a cellular network, a secondary radio transceiver, a processor coupled to the cellular radio transceiver and the secondary radio transceiver, the processor operative to receive a request to initiate a wireless connection to a second mobile communications device, in response to the request, generating a message comprising configuration parameters for initiating the wireless connection between the requesting mobile communications device and the second communications device, sending the message to the second communications device over the cellular network and establishing the wireless connection between the requesting mobile communications device and the second communications device in accordance with the configuration parameters.

### BRIEF DESCRIPTION OF THE DRAWINGS

The invention is herein described, by way of example only, with reference to the accompanying drawings, wherein:

FIG. 1 is a diagram illustrating an example prior art secondary link establishment scenario between two cellular telephones;

FIG. 2 is a block diagram illustrating an example wireless communications device incorporating the automatic link establishment mechanism of the present invention;

FIG. 3 is a diagram illustrating the generalized automatic link establishment mechanism of the present invention between two communication devices;

FIG. 4 is a diagram illustrating an example of the automatic link establishment mechanism of the present invention implemented between two cellular phones;

FIG. 5 is a diagram illustrating the message format for establishing a WLAN connection between two communication devices;

FIG. 6 is a diagram illustrating the message format for establishing a Bluetooth connection between two communication devices; and

FIG. 7 is a flow diagram illustrating the automatic link establishment method of the present invention.

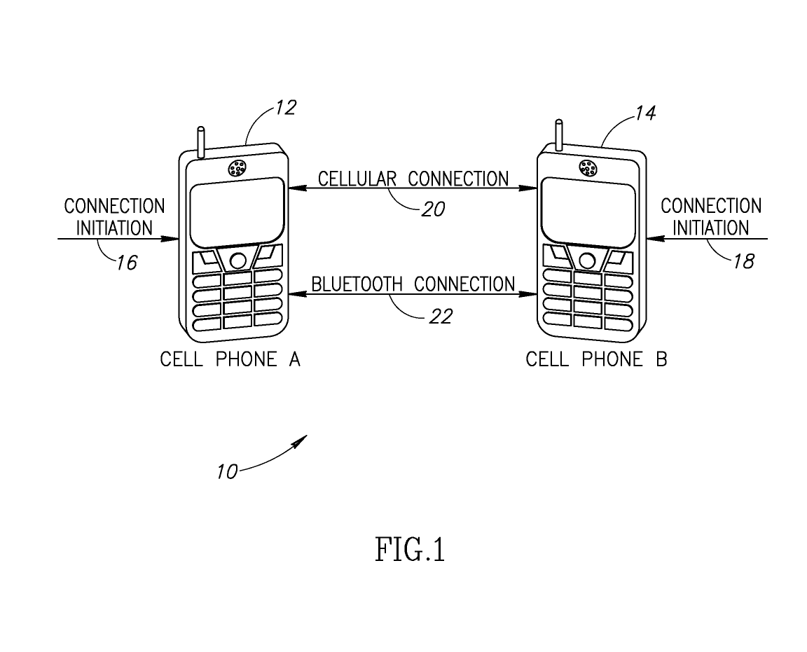

DETAILED DESCRIPTION OF THE INVENTION
Notation Used Throughout
The following notation is used throughout this document.

| Term | Definition |
|---|---|
| AC | Alternating Current |
| ASIC | Application Specific Integrated Circuit |
| AVI | Audio Video Interleave |
| BMP | Windows Bitmap |
| BT | Bluetooth |
| CPU | Central Processing Unit |
| DC | Direct Current |
| DHCP | Dynamic Host Control Protocol |
| DSP | Digital Signal Processor |
| DTMF | Dual Tone, Multiple Frequency |
| EPROM | Erasable Programmable Read Only Memory |
| FM | Frequency Modulation |
| FPGA | Field Programmable Gate Array |
| GPS | Ground Positioning Satellite |
| HDL | Hardware Description Language |
| IEEE | Institute of Electrical and Electronics Engineers |
| IP | Internet Protocol |
| JPG | Joint Photographic Experts Group |
| LAN | Local Area Network |
| MAC | Media Access Control |
| MP3 | MPEG-1 Audio Layer 3 |
| MPG | Moving Picture Experts Group |
| PDA | Portable Digital Assistant |
| RAM | Random Access Memory |
| RF | Radio Frequency |
| ROM | Read Only Memory |
| SIM | Subscriber Identity Module |
| SMS | Short Message Service |
| SSID | Service Set Identifier |
| TV | Television |
| USB | Universal Serial Bus |
| UWB | Ultra Wideband |
| WEP | Wired Equivalent Privacy |
| WLAN | Wireless Local Area Network |
| WMA | Windows Media Audio |
| WMV | Windows Media Video |
| WPA | Wi-Fi Protected Access |
| WPA-PSK | Wi-Fi Protected Access - pre-shared key |

### DETAILED DESCRIPTION OF THE INVENTION

The present invention provides a novel and useful apparatus for and method of automatically initiating, configuring and establishing a short range radio connection (i.e. link) between two communication devices such as cellular phones. In general, the invention automatically establishes a secondary communications link utilizing an already established primary communications link such as a conventional cellular network connection. Use of the invention eliminates the need for users of both communication devices to initiate and configure their respective communication devices manually, as in the case with the prior art. The invention permits the connection to be initiated from one communication device only thereby greatly simplifying the link establishment procedure.

Although the mechanism of the present invention can be used in numerous types of communication systems, to aid in illustrating the principles of the present invention, the description of the automatic link establishment mechanism is provided in the context of communication devices comprising cellular phones wherein the primary communications link is established using a conventional cellular network and wherein the secondary communications link is either a WLAN or Bluetooth connection.

The automatic link establishment mechanism of the present invention can be incorporated in a communication device such a multimedia player, cellular phone, PDA, wireless device, etc.

Although the invention is described in the context of a cellular phone, it is appreciated that the invention is not limited to the example applications presented, but that one skilled in the art can apply the principles of the invention to other communication devices as well without departing from the scope of the invention. Further, it is appreciated that the invention is not limited to the particular technology or type of primary or secondary communications link. In particular, it is not intended that the invention be limited to the use of the cellular network for the primary communication link or the use of Bluetooth or WLAN for the secondary communication links, as other technologies may be used for both primary and secondary communication links.

It is appreciated by one skilled in the art that the automatic link establishment mechanism of the present invention can be adapted for use with numerous other types of wired wireless communication systems without departing from the scope of the invention.

Note that throughout this document, the term communications device is defined as any apparatus or mechanism adapted to transmit, receive or transmit and receive data through a medium. The term communications transceiver or communications device is defined as any apparatus or mechanism adapted to transmit and receive data through a medium. The communications device or communications transceiver may be adapted to communicate over any suitable medium, including wireless or wired media. Examples of wireless media include RF, infrared, optical, microwave, UWB, Bluetooth, WiMax, WiMedia, WiFi, or any other broadband medium, etc. Examples of wired media include twisted pair, coaxial, optical fiber, any wired interface (e.g., USB, Firewire, Ethernet, etc.). The term Ethernet network is defined as a network compatible with any of the IEEE 802.3 Ethernet standards, including but not limited to 10Base-T, 100Base-T or 1000Base-T over shielded or unshielded twisted pair wiring. The terms communications channel, link and cable are used interchangeably.

The term multimedia player or device is defined as any apparatus having a display screen and user input means that is capable of playing audio (e.g., MP3, WMA, etc.), video (AVI, MPG, WMV, etc.) and/or pictures (JPG, BMP, etc.). The user input means is typically formed of one or more manually operated switches, buttons, wheels or other user input means.

Examples of multimedia devices include pocket sized personal digital assistants (PDAs), personal media player/recorders, cellular telephones, handheld devices, and the like.

Some portions of the detailed descriptions which follow are presented in terms of procedures, logic blocks, processing, steps, and other symbolic representations of operations on data bits within a computer memory. These descriptions and representations are the means used by those skilled in the data processing arts to most effectively convey the substance of their work to others skilled in the art. A procedure, logic block, process, etc., is generally conceived to be a self-consistent sequence of steps or instructions leading to a desired result. The steps require physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

It should be born in mind that all of the above and similar terms are to be associated with the appropriate physical quantities they represent and are merely convenient labels applied to these quantities. Unless specifically stated otherwise as apparent from the following discussions, it is appreciated that throughout the present invention, discussions utilizing terms such as ‘processing,’ ‘computing,’ ‘calculating,’ ‘determining,’ ‘displaying’ or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention can take the form of an entirely hardware embodiment, an entirely software embodiment or an embodiment containing a combination of hardware and software elements. In one embodiment, a portion of the mechanism of the invention is implemented in software, which includes but is not limited to firmware, resident software, object code, assembly code, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium is any apparatus that can contain, store, communicate, propagate, or transport the program for use by or in connection with the instruction execution system, apparatus, or device, e.g., floppy disks, removable hard drives, computer files comprising source code or object code, flash semiconductor memory (USB flash drives, etc.), ROM, EPROM, or other semiconductor memory devices.

### Mobile Device/Cellular Phone/PDA System

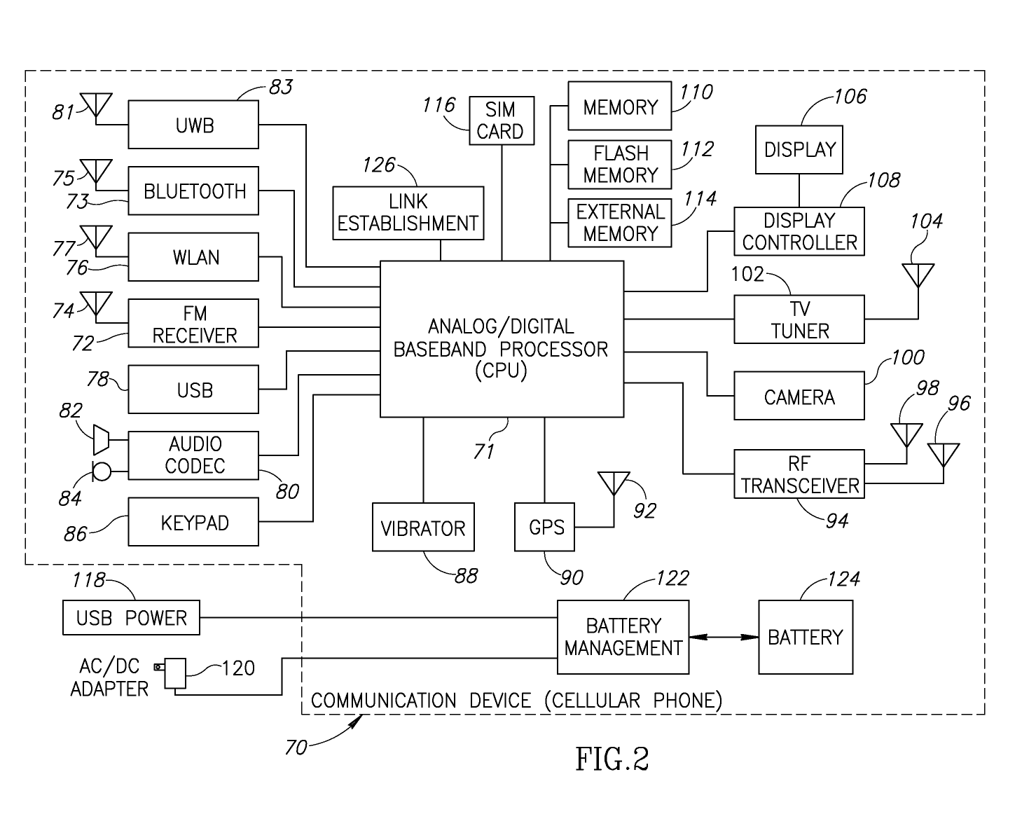

A block diagram illustrating an example communication device in more detail is shown in FIG. 2. The communication device may comprise any suitable wired or wireless device such as multimedia player, mobile device, cellular phone, PDA, Bluetooth device, etc. For illustration purposes only, the communication device is shown as a cellular phone. Note that this example is not intended to limit the scope of the invention as the automatic link establishment mechanism of the present invention can be implemented in a wide variety of communication devices.

The cellular phone, generally referenced 70, comprises a baseband processor or CPU 71 having analog and digital portions. The basic cellular link is provided by the RF transceiver 94 and related one or more antennas 96, 98. A plurality of antennas is used to provide antenna diversity which yields improved radio performance. The cell phone also comprises internal RAM and ROM memory 110, Flash memory 112 and external memory 114.

Several user interface devices include microphone 84, speaker 82 and associated audio codec 80, a keypad for entering dialing digits 86, vibrator 88 for alerting a user, camera and related circuitry 100, a TV tuner 102 and associated antenna 104, display 106 and associated display controller 108 and GPS receiver and associated antenna 92.

A USB interface connection 78 provides a serial link to a user's PC or other device. An FM receiver 72 and antenna 74 provide the user the ability to listen to FM broadcasts. WLAN radio and interface 76 and antenna 77 provide wireless connectivity when in a hot spot or within the range of an ad hoc, infrastructure or mesh based wireless LAN network. Bluetooth radio and interface 73 and antenna 75 provide Bluetooth wireless connectivity when within the range of a Bluetooth wireless network. Ultra Wideband (UWB) radio and interface 83 and antenna 81 provide UWB wireless connectivity when within the range of a UWB wireless network. SIM card 116 provides the interface to a user's SIM card for storing user data such as address book entries, etc.

The cellular phone also comprises an automatic link establishment block 126 adapted to implement the automatic link establishment mechanism of the present invention. In one embodiment of the invention, basic cellular link functions as the primary communications link while one of the secondary technologies (i.e. UWB, Bluetooth, WLAN, etc.) is used as the secondary communications link. In operation, the link establishment block 126 may be implemented as hardware, software executed as a task on the baseband processor 71 or a combination of hardware and software. Implemented as a software task, the program code operative to implement the link establishment mechanism of the present invention is stored in memory 110, 112 or 114.

Portable power is provided by the battery 124 coupled to battery management circuitry 122. External power is provided via USB power 118 or an AC/DC adapter 120 connected to the battery management circuitry which is operative to manage the charging and discharging of the battery 124.

### First Automatic Link Establishment Method

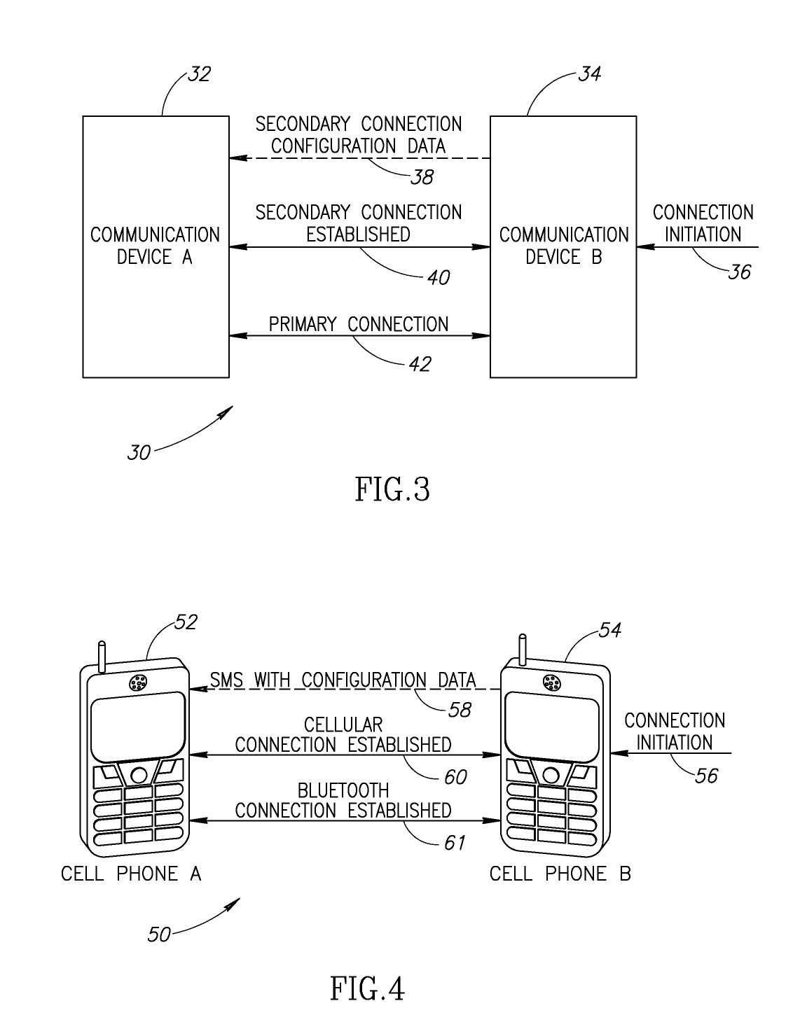

A diagram illustrating the generalized automatic link establishment mechanism of the present invention between two communication devices is shown in FIG. 3. The example scenario, generally referenced 30, comprises two communication devices (i.e. communication device A 32 and communication device B 34) connected by a primary connection 42 (e.g., cellular). The communication devices A and B ma comprise any suitable type of device such as cellular phone, PDA, etc.

In accordance with the invention, when one both users decide to establish a secondary connection (e.g., Bluetooth, WLAN, UWB, etc.), only one of the two users initiates the connection from one of the communication devices only (connection initiation reference 36).

This minimizes the power consumption of the communication device dramatically as the radio (i.e. transmitter and receiver circuitry) for the secondary radio does need to be constantly in the ‘on’ state. A message comprising the required connection parameters is generated and transmitted over the primary connection to the communication device on the other side of the connection (referenced transmission 38). The message is received and the contents used to configure the remote communications device for establishment of the secondary connection (referenced 40).

Thus, configuring the connection parameters in one communications device only eliminates the need to configure parameters on the communications device on the other side. In addition, the mechanism of the invention utilizes the already existing or established primary connection to simplify the establishment of one or more secondary connections. If the primary communications connection is not already established, a request to initiate a secondary connection can trigger the establishment of the primary connection.

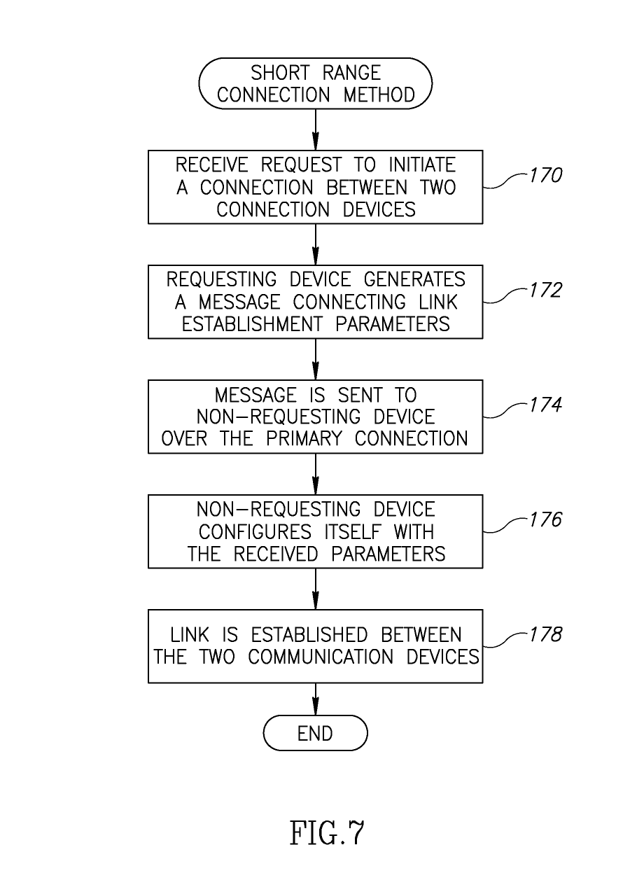

A diagram illustrating an example of the automatic link establishment mechanism of the present invention implemented between two cellular phones is shown in FIG. 4. A flow diagram illustrating the automatic link establishment method of the present invention is shown in FIG. 7.

In this example, the two communication devices 32, 34 of FIG. 3 comprise cellular phones wherein the primary connection comprises a cellular connection and the secondary connection is comprises a Bluetooth connection. In particular, the example scenario, generally referenced 50, comprises two cellular phones, namely cellular phone A 52 and cellular phone A 54.

With reference to FIGS. 4 and 7, a cellular connection (i.e. primary connection) is established between the two cellular phones via a conventional cellular network (referenced 61).

An indication is provided to the cellular phone when one of the users (e.g., cellular phone B user) desires to establish a Bluetooth connection (i.e. secondary connection) between the two cellular phones (referenced connection initiation 56) (step 170).

In accordance with the invention, in response to the request, cellular phone B (i.e. the requesting communication device) generates a message comprising the required connection parameters needed by cellular phone A to establish a Bluetooth connection (step 172). The message (referenced 58) is sent to cellular phone A (i.e. the non-requesting communications device) over the primary connection (i.e. the conventional cellular media connection referenced 61) (step 174). Upon receipt, cellular phone A (i.e. the non-requesting communications device), configures itself with the Bluetooth configuration parameters received in the message (step 176).

The Bluetooth link (referenced 60) is then established between cellular phones A and B (step 178).

Note that the message comprising the configuration parameters can be sent using any suitable means such as via conventional SMS messaging or dual-tone multiple-frequency (DTMF) signaling tones. Further, the Bluetooth connection is used for example purposes only.

It is appreciated that other secondary communication technologies and protocols may be used (such as WLAN, UWB, etc.) without departing from the scope of the invention.

Thus, the invention is operative to require only one user to initiate a short distance or other wireless connection between two communication devices such as cellular phones. The other side of the connection receives its configuration parameters over the primary connection media (e.g., conventional cellular connection) without any ser intervention needed on that side.

The benefit of the mechanism of the invention is the significant reduction in battery power required with the enablement of always available short range connectivity of the cellular phone or other communication device without requiring user configuration on the receiving side of the connection.

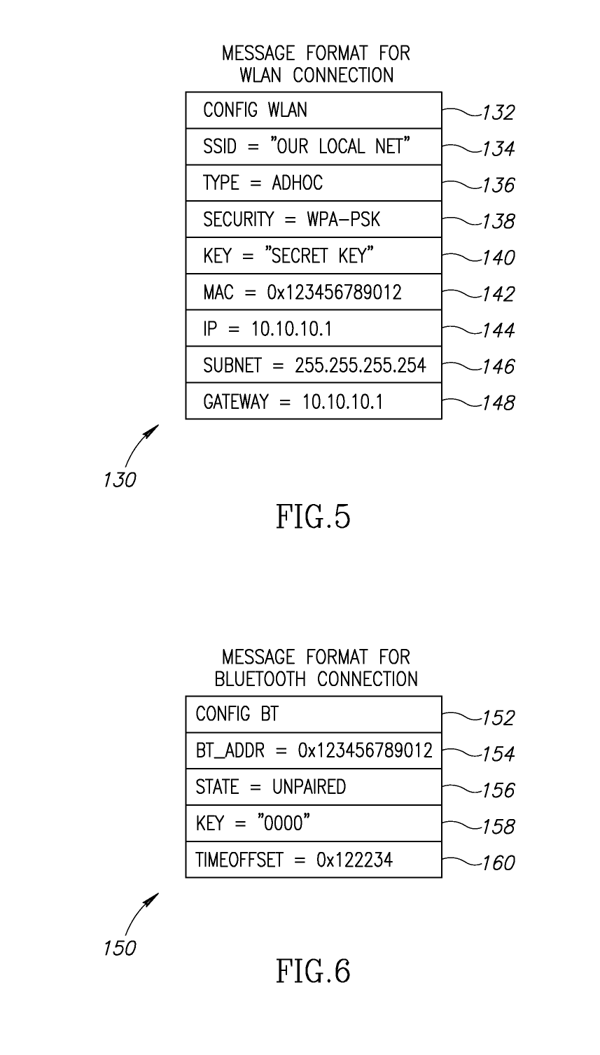

A diagram illustrating the message format for establishing a WLAN connection between two communication devices is shown in FIG. 5. The message format for a WLAN secondary connection, generally referenced 130, comprises a plurality of fields as described below. A communication device uses the message format 130 to establish a WLAN connection. The message contents 130 may be transmitted using any suitable means such as SMS, DTMF signaling tones, etc. which is not critical to the invention. Regardless of the messaging means actually used, the message is transmitted over the primary connection (e.g., cellular network) from the requesting communications device to the non-requesting communications device.

The message format 130, comprises a Config WLAN field 132, SSID field 134, Type field 136, security field 138, key field 140, Media Access Control (MAC) field 142, Internet Protocol (IP) field 144, Subnet field 146 and Gateway field 148. The Config WLAN field designates the WLAN technology. The SSID field comprises the SSID of the network to connect to (e.g., “our local net”). The Type field comprises the type of network: either AdHoc or Infrastructure (e.g., AdHoc). The Security field comprises the network security (i.e. none, WEP, WPA, WPA-PSK, etc.) (e.g., WPA-PSK). The Key field comprises the security for the network (e.g., “our secret”). The MAC field comprises the MAC address of the WLAN interface for this particular device (e.g., MAC=0×123456789012). The IP field comprises the IP address for this particular device if a fixed address is used, or DHCP if the network uses DHCP (e.g., IP=10.0.0.1). The Subnet field comprises the network subnet mask (if no DHCP in use) (e.g., Subnet=255.255.255.254). The Gateway field comprises the IP address of the gateway (if no DHCP in use) (e.g., Gateway=10.10.10.1).

A diagram illustrating the message format for establishing a Bluetooth connection between two communication devices is shown in FIG. 6. The message format for a Bluetooth secondary connection, generally referenced 150, comprises a plurality of fields as described below. A communication device uses the message format 150 to establish a Bluetooth connection. The message contents 150 may be transmitted using any suitable means such as SMS, DTMF signaling tones, etc. which is not critical to the invention. Regardless of the messaging means actually used, the message is transmitted over the primary connection (e.g., cellular network) from the requesting communications device to the non-requesting communications device.

The message format 150, comprises a Config BT 152, BT_ADDR field 154, State field 156, Key field 158, key field 140 and TimeOffset field 160. The Config BT field designates the Bluetooth technology. The BD_ADDR field comprises the unique address of the particular device (e.g., BT_ADDR=0×123456789012). The State field designates the state of the device compared to the requested pair (e.g., UnPaired). The Key field, for UnPaired devices, comprises the PIN code (e.g., Key=“0000”). For paired devices, this field comprises the link key. The TimeOffset field comprises time offset of the cellular network clock and the Bluetooth clock (e.g., TimeOffset=0×122234). Note that this field may be used to accelerate page/inquiry procedures.

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. A method of establishing a secondary communications link between a first communication device and a second communication device connected via a primary communications link, said method comprising the steps of:
receiving a request to initiate said secondary communication link on said first communication device;
in response to said request, generating a message comprising configuration parameters for initiating said secondary communication link between said first communication device and said second communication device;
sending said message to said second communication device over said primary communications link; and
establishing said secondary communications link between said first communication device and said second communication device in accordance with said configuration parameters.

2. The method according to claim 1, wherein said primary communications link comprises a cellular phone connection.

3. The method according to claim 1, wherein said secondary communications link comprises a Wireless Local Area Network (WLAN) connection.

4. The method according to claim 1, wherein said secondary communications link comprises an Ultra Wideband (UWB) connection.

5. The method according to claim 1, wherein said secondary communications link comprises a Bluetooth connection.

6. The method according to claim 1, wherein said message is transmitted to said second communication device via SMS message service over said primary communications link.

7. The method according to claim 1, wherein said message is transmitted to said second communication device via dual tone, multiple frequency (DTMF) signaling over said primary communications link.

8. The method according to claim 1, wherein said first communication device and said second communication device comprise cellular phones.

9. A method of establishing a short range wireless connection between a first cellular phone and second cellular phone, both said first cellular phone and said second cellular phone connected to a conventional cellular network, said method comprising the steps of:
receiving a request to initiate said short range wireless connection on said first cellular phone;
in response to said request, generating a message comprising configuration parameters for initiating said short range wireless connection between said first cellular phone and said second cellular phone;
sending said message to said second cellular phone over said cellular network; and
establishing said short range wireless connection between said first cellular phone and said second cellular phone in accordance with said configuration parameters.

10. The method according to claim 9, wherein said short range wireless connection comprises a Wireless Local Area Network (WLAN) connection.

11. The method according to claim 9, wherein said short range wireless connection comprises a Bluetooth connection.

12. The method according to claim 9, wherein said message is transmitted to said second cellular phone via SMS message service over said cellular network.

13. The method according to claim 9, wherein said message is transmitted to said second cellular phone via dual tone, multiple frequency (DTMF) signaling over said cellular network.

14. A mobile communications device, comprising:
a cellular radio transceiver operative to connect said mobile communications device to a cellular network;
a secondary radio transceiver;
a processor coupled to said cellular radio transceiver and said secondary radio transceiver, said processor operative to:
receive a request to initiate a wireless connection to a second mobile communications device;
in response to said request, generating a message comprising configuration parameters for initiating said wireless connection between the requesting mobile communications device and said second communications device;
sending said message to said second communications device over said cellular network; and
establishing said wireless connection between the requesting mobile communications device and said second communications device in accordance with said configuration parameters.

15. The mobile communications device according to claim 14, wherein said wireless connection comprises a Wireless Local Area Network (WLAN) connection.

16. The mobile communications device according to claim 14, wherein said wireless connection comprises a Bluetooth connection.

17. The mobile communications device according to claim 14, wherein said wireless connection comprises an Ultra Wideband (UWB) connection

18. The mobile communications device according to claim 14, wherein said message is transmitted to said second communications device via SMS message service over said cellular network.

19. The mobile communications device according to claim 14, wherein said message is transmitted to said second communications device via dual tone, multiple frequency (DTMF) signaling over said cellular network.

20. The mobile communications device according to claim 14, wherein the requesting communications device and second communications device comprise a cellular telephone.

21. The mobile communications device according to claim 14, wherein said communications device comprises a personal digital assistant (PDA).
